(19) United States
(12) Patent Application Publication
(10) Pub. No.: US 2025/0059403 A1
(43) Pub. Date: Feb. 20, 2025

(54) RUBBER-BASED ADHESIVE COMPOSITIONS

(71) Applicant: 3M INNOVATIVE PROPERTIES COMPANY, St. Paul, MN (US)

(72) Inventors: Vasav Sahni, St. Paul, MN (US); Gregg A. Patnode, Woodbury, MN (US); Jacob P. Johnson, St. Paul, MN (US); Jacek W. Dziedzic, Woodbury, MN (US); Thomas E. Augustine, Hager City, WI (US); John P. Baetzold, North St. Paul, MN (US); Jason D. Clapper, Lino Lakes, MN (US)

(21) Appl. No.: 18/722,182

(22) PCT Filed: Dec. 7, 2022
(86) PCT No.: PCT/IB2022/061901

§ 371 Date: Jun. 20, 2024

Related U.S. Application Data
(60) Provisional application No. 63/295,342, filed on Dec. 30, 2021.

(51) Int. Cl. C09J 4/06; C09J 5/00; C09J 7/38; C09J 9/00; C09J 153/02

(52) U.S. Cl. CPC C09J 4/06; C09J 5/00; C09J 7/387; C09J 9/00; C09J 153/025; C09J 2301/302; C09J 2301/414; C09J 2301/416; C09J 2453/00

(57) ABSTRACT

Adhesive compositions including 20 wt. % to 80 wt. % of a polymer selected from the group consisting of a radial styrene-isoprene block copolymer, a radial styrene-butadiene block copolymer, and combinations thereof, and 3 wt. % to 80 wt. % of a liquid rubber having a molecular weight of 300 Daltons to 100,000 Daltons, where the liquid rubber is selected from the group consisting of an isoprene rubber, a butadiene rubber, and combinations thereof. Such adhesive compositions exhibit high cohesive integrity as well as high adhesion and peel properties.

### BACKGROUND

Pressure-sensitive adhesives and tapes including such adhesives are virtually ubiquitous in the home and the workplace. In its simplest configuration, a pressure-sensitive tape comprises an adhesive and a backing, the overall construction is tacky at the use temperature, and the tape adheres to a variety of substrates using only moderate pressure to form the bond. In this fashion, pressure-sensitive tapes constitute a complete, self-contained bonding system.

According to the Pressure-Sensitive Tape Council, pressure-sensitive adhesives (“PSAs”) are known to possess properties including at least the following: (I) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being tacky at room temperature (e.g., 20° C.).

The properties of PSAs and articles including them may be assessed generally by means of tests which are designed to individually measure tack, adhesion (peel strength), and cohesion (shear holding power), as noted in A. V. Pocius in Adhesion and Adhesives Technology: An Introduction, 2^{nd} Ed., Hanser Gardner Publication, Cincinnati, Ohio, 2002. These measurements taken together constitute the balance of properties often used to characterize a PSA.

### SUMMARY

Rubber-based, pressure-sensitive adhesive compositions are disclosed that provide a unique set of attributes such as, for example, high cohesive integrity, high tack, and high adhesion. These formulations are hot-melt and solvent processable and can enable applications in multiple industries.

In one aspect, provided are adhesive compositions including 20 wt. % to 80 wt. % of a polymer selected from the group consisting of a radial styrene-isoprene block copolymer, a radial styrene-butadiene block copolymer, and combinations thereof, and 3 wt. % to 80 wt. % of a liquid rubber having a molecular weight of 300 Daltons to 100,000 Daltons, where the liquid rubber is selected from the group consisting of an isoprene rubber, a butadiene rubber, and combinations thereof.

In another aspect, provided are pressure-sensitive adhesives and optically clear adhesives including the adhesive composition.

In another aspect, provided are cured adhesive composition including the adhesive composition.

As used herein:

“essentially no” amount of a material in a composition may be substituted with “less than 5 weight percent”, “less than 4 weight percent”, “less than 3 weight percent”, “less than 2 weight percent”, “less than 1 weight percent”, “less than 0.5 weight percent”, “less than 0.1 weight percent”, or “none”;

“pressure sensitive adhesive” or “PSA” means materials having at least the following properties: a) tacky surface, b) the ability to adhere with no more than finger pressure, c) the ability to adhere without activation by any energy source, d) sufficient ability to hold onto the intended adherend, and preferably e) sufficient cohesive strength to be removed cleanly from the adherend; which materials typically meet the Dahlquist criterion of having a storage modulus at 1 Hz and room temperature of less than 0.3 MPa; and

All scientific and technical terms used herein have meanings commonly used in the art unless otherwise specified.

As used in this specification and the appended claims, past tense verbs, such as, for example, “coated,” and are intended to represent structure, and not to limit the process used to obtain the recited structure, unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to.” It will be understood that the terms “consisting of” and “consisting essentially of” are subsumed in the term “comprising,” and the like.

Features and advantages of the present disclosure will be further understood upon consideration of the detailed description as well as the appended claims.

### DETAILED DESCRIPTION

Rubber-based pressure-sensitive adhesives can have useful attributes, such as, for example, high cohesive integrity, high tack, and high adhesion. One class of materials—alkene and diene-based rubbers—is of particular interest because of its inherent barrier properties against oxygen and moisture in addition to other desirable properties, such as cohesive strength. Provided in the present disclosure are adhesive compositions that comprise diene-based rubbers that have high cohesive integrity as well as high adhesion and peel properties. These compositions preserve the inherent high barrier and Moisture Vapor Transmission Rate (“MVTR”) properties of the rubbers. Such rubber-based pressure-sensitive adhesives are relevant for both electronic and non-electronic applications.

The present disclosure provides adhesive compositions comprising 20 wt. % to 80 wt. %, of a polymer selected from the group consisting of a radial styrene-isoprene block copolymer, a radial styrene-butadiene block copolymer, and combinations thereof; and 3 wt. % to 80 wt. % of a liquid rubber, optionally 3 wt. % to 50 wt. % of the liquid rubber. The liquid rubber is selected from the group consisting of an isoprene rubber, a butadiene rubber, and combinations thereof, and the liquid rubber has a molecular weight of 300 Daltons to 100,000 Daltons, optionally a molecular weight of 5,000 Daltons to 60,000 Daltons.

### Polymer

Styrene-isoprene block copolymers and styrene-butadiene block copolymers exist in various forms, such as, for example, a linear A-B-A triblock block copolymer structure and a radial (A-B)nX (e.g., multi-arm) block copolymer structure, where A is a polyvinyl aromatic blocs, B is a conjugated diene block, n is an integer of at least 2 or 3, typically ranging up to 6, 7, 8, 9, 10, 11, or 12 and X is the residue of a coupling agent. The unsaturated midblock of the block copolymer can be tapered or non-tapered but is typically non-tapered. As used herein, the terminology styrene-isoprene block copolymer refers to both the linear and radial (e.g., multi-arm) structures unless specified otherwise.

Adhesive compositions of the present disclosure include 20 wt. % to 80 wt. %, optionally 40 wt. % to 70 wt. % of a polymer selected from the group consisting of a radial styrene-isoprene block copolymer, a radial styrene-butadiene block copolymer, and combinations thereof. In some preferred embodiments, adhesive compositions of the present disclosure include essentially no linear styrene-isoprene block copolymer and essentially no linear styrene-butadiene block copolymer.

### Liquid Rubber

Adhesive compositions of the present disclosure include 3 wt. % to 80 wt. % of a liquid rubber, optionally 3 wt. % to 50 wt. % of the liquid rubber. The liquid rubber is selected from the group consisting of an isoprene rubber, a butadiene rubber, and combinations thereof, and commonly has a molecular weight of 300 Daltons to 100,000 Daltons, optionally a molecular weight of 5,000 Daltons to 60,000 Daltons.

Liquid rubbers useful in formulations of the present disclosure, such as, for example, liquid isoprene rubber homopolymers, functionalized (e.g., carboxylated) liquid isoprene rubber homopolymers, and liquid butadiene rubber homopolymers, are commercially available from Kuraray, Houston, Texas, USA, under the product names “LIR KL-10,” “LIR-30,” “LIR-50,” “LIR-410,” “LBR-307,” “LBR-361,” “UC-102M,” and “UC-203M.”

Adhesive compositions of the present disclosure may be prepared by methods known to those of ordinary skill in the relevant arts and are described in the Examples supra.

### Additional Additives

Adhesive compositions of the present disclosure may optionally comprise one or more additives such as, for example, tackifiers, plasticizers (e.g., oils, polymers that are liquids at 25° C.), antioxidants (e.g., hindered phenol compounds, phosphoric esters, or derivatives thereof), ultraviolet light absorbers (e.g., benzotriazole, oxazolic acid amide, benzophenone, or derivatives thereof), in-process stabilizers. anti-corrosives. passivation agents, light stabilizers, processing assistants, elastomeric polymers (e.g., other block copolymers), scavenger fillers, nanoscale fillers, transparent fillers, desiccants, crosslinkers, pigments, organic solvents, and combinations thereof. The total concentration of such additives ranges from 0 to 60 wt. % of the total adhesive composition.

In some embodiments the adhesive composition comprises a tackifier. The concentration of tackifier can vary depending on the intended (e.g. pressure sensitive) adhesive composition. In some embodiments. the amount of tackifier is at least 1, 2, 3, 4, 5, 6, 7, 8, 9, 10, 11, 12, 13, 14, 15 wt. %. The maximum amount of tackifier is typically no greater than 60, 55, 50, 45, 40, 35, or 30 wt. %. Increasing the (e.g., solid at 25° C.) tackifier concentration typically raises the Tg of the adhesive. In other embodiments, the adhesive composition comprises little or no tackifier. Thus, the concentration of tackifier is less than 5, 4, 3, 2, 1, 0.5, or 0.1 wt. %.

The tackifier can have any suitable softening temperature or softening point. The softening temperature is often less than 200° C, less than 180° C., less than 160° C., less than 150° C., less than 125° C., or less than 120° C. In applications that tend to generate heat, however, the tackifier is often selected to have a softening point of at least 75° C. Such a softening point helps minimize separation of the tackifier from the rest of the adhesive composition when the adhesive composition is subjected to heat such as from an electronic device or component. The softening temperature is often selected to be at least 80° C., at least 85° C., at least 90° C., or at least 95° C. In applications that do not generate heat. however, the tackifier can have a softening point less than 75° C.

Suitable tackifiers include hydrocarbon resins and hydrogenated hydrocarbon resins. e.g., hydrogenated cycloaliphatic resins, hydrogenated aromatic resins, or combinations thereof. Suitable tackifiers are commercially available and include, e.g., those available under the trade designation ARKON (e.g., ARKON P or ARKON M) from Arakawa Chemical Industries Co., Ltd. (Osaka. Japan); those available under the trade designation ESCOREZ (e.g., ESCOREZ 1315, 1310LC, 1304, 5300, 5320, 5340, 5380, 5400, 5415, 5600, 5615, 5637, and 5690) from Exxon Mobil Corporation, Houston, TX; and those available under the trade designation REGALREZ (e.g., REGALREZ 1085, 1094, 1126, 1139, 3102, and 6108) from Eastman Chemical, Kingsport, TN. The above tackifiers may be characterized as midblock tackifiers. being compatible with the isoprene block of the SIS/SI block copolymer. In some embodiments. the adhesive may comprise an endblock aromatic tackifier that is compatible with the styrene block of the block copolymer.

In some embodiments the adhesive composition comprises a multifunctional (meth)acrylate. In some preferred embodiments, the multifunctional (meth)acrylate is selected from the group consisting of a diacrylate, a triacrylate, a tetraacrylate, a hexaacrylate, and combinations thereof.

In some favored embodiments, the composition is a pressure sensitive adhesive. Pressure sensitive adhesives are often characterized as having a storage modulus (G′) at the application temperature, typically room temperature (e.g., 25° C.), of less than 3 ×10⁵ Pa (0.3 MPa) when measured at a frequency of 1 Hz. As used herein, storage modulus (G′) refers to the value obtained utilizing Dynamic Mechanical Analysis (DMA) per the test method described in the Examples. In some embodiments. the pressure sensitive adhesive composition has a storage modulus of less than 2.8×10⁵ Pa, 2.6×10⁵ Pa, 2.4×10⁵ Pa, 2.2×10⁵ Pa, 2.0×10⁵ Pa, 1.8×10⁵ Pa, 1.6×10⁵ Pa, or 1.4×10⁵ Pa. In some embodiments, the composition has a storage modulus (G′) of at least 0.8×10⁵ Pa or 1×10⁵ Pa. In some embodiments, the pressure sensitive adhesive has a tan delta no greater than 0.7, 0.6, 0.5, or 0.4 at 150° C. The pressure sensitive adhesive composition typically has tan delta of at least 0.01 or 0.05 at 150° C.

When G′ values are higher and tan delta values are lower, static shears are typically higher. This may be observed in adhesive samples with higher strength bonds with more elastic behavior where the potential to store the load is highest. When G′ are lower and tan delta values are higher, static shear values typically are lower. This may be observed in samples with weaker bonds with more viscous behavior where there is the potential to dissipate load, rather than store it. Pressure sensitive adhesives of the present disclosure may be characterized as having a shear strength. In some embodiments. the shear strength (e.g., to stainless steel), as measured according to the test method described in the Examples, is at least 5000, 6000, 7000, 8000, 9000 or 10000 minutes.

Pressure sensitive adhesives are often characterized as having a glass transition temperature “Tg” below 25° C.; whereas other adhesives may have a Tg of 25° C. or greater, typically ranging up to 50° C. As used herein, Tg refers to the value obtained utilizing DMA per the test method described in the examples. In some embodiments, the pressure sensitive adhesive composition has a Tg no greater than 20° C., 15° C., 10° C., 5° C., 0° C., or −5° C. The Tg of the pressure sensitive adhesive is typically at least −40° C., −35° C., −30° C., −25° C., or −20° C.

In some favored embodiments, the composition is an optically-clear adhesive including an adhesive composition as described infra.

Rubber-based, pressure-sensitive adhesive compositions of the present disclosure provide a unique set of attributes such as, for example, high cohesive integrity, high tack, and high adhesion and may find applications in a variety of adhesives (e.g., PSAs, optically clear adhesives, core-sheath adhesives) useful in manufacturing a variety of articles. These formulations are hot-melt and solvent processable and can enable applications in multiple industries, such as, for example, the aerospace, apparel, architecture, automotive, business machines products, consumer, defense, dental, electronics, educational institutions, heavy equipment, jewelry, medical, and toys industries.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, materials used in the examples were obtained from commercial suppliers (e.g., Aldrich Chemical Co., Milwaukee, Wisconsin) and/or made by known methods. Materials prepared in the examples were analyzed by NMR spectroscopy and were consistent with the given structures.

Materials Used in the Examples

| Abbreviation | Description and Source |
|---|---|
| D1340KT | A dissimilar arm, styrene-isoprene, star polymer |
| | with 9.2% styrene content and made according |
| | to U.S. Pat. No. 5,296,547 from Kraton Polymers |
| | US LLC, Houston, Texas |
| 1161 | A linear styrene-isoprene-styrene block copolymer, |
| | obtained under the trade designation |
| | “KRATON D1161 P” from Kraton Polymers |
| | US LLC, Houston, Texas |
| 5340 | A colorless cycloaliphatic hydrocarbon resin designed |
| | to tackify a variety of adhesive polymers, obtained |
| | under the trade designation “ESCOREZ 5340” |
| | from ExxonMobil Chemical, Irving, Texas |
| PPO | A paraffinic process oil, obtained under the trade |
| | designation “PARALUX 6001” from |
| | ChevronTexaco, San Ramon, California |
| A80 | A hydrocarbon fluid obtained under the trade designation |
| | “ELEVAST A80” from ExxonMobil Chemical, Irving, |
| | Texas |
| LIR KL-10 | A liquid isoprene rubber homopolymer having a molecular |
| | weight of 10000 Daltons, obtained under the product |
| | name “LIR KL-10” from Kuraray, Houston, Texas |
| LIR-30 | A liquid isoprene rubber homopolymer having a molecular |
| | weight of 28000 Daltons, obtained under the product |
| | name “LIR-30” from Kuraray, Houston, Texas |
| LIR-50 | A liquid isoprene rubber homopolymer having a |
| | molecular weight of 48000 Daltons, obtained under |
| | the product name “LIR-50” from Kuraray, |
| | Houston, Texas |
| LIR-410 | A carboxylated liquid isoprene rubber having a |
| | molecular weight of 30000 Daltons, obtained under |
| | the product name “LIR-410” from Kuraray, |
| | Houston, Texas |
| LBR-307 | A liquid butadiene rubber homopolymer having a molecular |
| | weight of 8000 Daltons, obtained under the product name |
| | “LBR-307” from Kuraray, Houston, Texas |
| LBR-361 | A liquid butadiene rubber homopolymer having a molecular |
| | weight of 5500 Daltons, obtained under the product name |
| | “LBR-361” from Kuraray, Houston, Texas |
| UC-102M | A UV-curable functionalized liquid isoprene rubber |
| | having a molecular weight of 17000 Daltons, |
| | obtained under the product name “UC-102M” |
| | from Kuraray, Houston, Texas |
| UC-203M | A UV-curable functionalized liquid isoprene rubber |
| | having a molecular weight of 35000 Daltons, obtained |
| | under the product name “UC-203M” from Kuraray, |
| | Houston, Texas |
| BP | Benzophenone, obtained from BASF, Florham Park, |
| | New Jersey |
| TPO | 2,4,6-trimethylbenzoyl-diphenyl phosphine oxide, |
| | obtained under the trade designation |
| | “OMNIRAD TPO” from IGM Resins, Charlotte, |
| | North Carolina |
| P-90 | A saturated alicyclic hydrocarbon with an average |
| | molecular weight of 1160 Daltons, obtained under |
| | the trade designation “ARKON P-90” from |
| | Arakawa Chemical, Chicago, Illinois |
| P-140 | A saturated alicyclic hydrocarbon with an average |
| | molecular weight of 2220 Daltons, obtained under |
| | the trade designation “ARKON P-140” |
| | from Arakawa Chemical, Chicago, Illinois |
| LDPE | Low Density Polyethylene with a MFI of 5.6, obtained |
| | under the product name “PETROTHENE NA217000” |
| | from LyondellBasell, Houston, Texas |
| RF02N | A 2 mil thick siliconized PET release liner, obtained |
| | under the product name “RF02N” from SKC Haas, |
| | Seoul, Korea |
| RF22N | A 2 mil thick siliconized PET release liner, obtained |
| | under the product name “RF22N” from SKC Haas, |
| | Seoul, Korea |
| Toluene | 1-methylbenzene, obtained from EMD Millipore, |
| | Burlington, Massachusetts |

### Test Methods

### Rheology Testing Method

Samples were evaluated for their tan delta at varying temperatures, G′ at 25° C., and Tg using a rheological dynamic analyzer (Model DHR-3 Rheometer, which is available from TA Instruments, New Castle, Delaware, USA) as specified in tables 3, 5, and 7. Samples were laminated to a thickness of approximately 1 millimeter (0.039 inches). Samples were then punched out using an 8 mm (0.315 inches) diameter circular die and adhered onto an 8 millimeter diameter upper parallel plate after removal of the release liner. The plate with polymeric film was positioned between the clamps, and the polymeric film compressed until the edges of the sample were uniform with the edges of the top plate. The temperature was then equilibrated at the test temperatures for 2 minutes at a nominal axial force of 0 grams +/−15 grams. After two minutes, the axial force controller was disabled to maintain a fixed gap during the remainder of the test. The sample was oscillated at 1 Hz and was taken from −50° C. to 150° C. at 3° C./min.

### 90° Peel Strength Test Method

The test standard followed was ASTM D6862. A 1.0 mm (0.048 in.) thick adhesive disposed between two release liners was cut into 1.59 cm×16.5 cm (0.63 inch×6.5 inch) strips, the RF02N release liner removed, and the adhesive was applied to a rigid aluminum substrate (1.60 mm (0.060 in.). The remaining RF22N release liner was removed and a flexible aluminum substrate 0.1016 mm (0.004 in.) thick, 1.59 cm×16.5 cm (0.63 inch×6.5 inch) was applied atop the adhesive with a rubber roller with hand pressure and then samples were compressed with a 4.54 kg (10 lb.) roller using four total passes over the adhesive. Samples were aged at 23.9° C. and 75% humidity for 72 hours before testing.

Sample testing was conducted on a 3300 Universal Testing System load frame equipped with a 50 kilonewton load cell (Instron, Norwood, MA. United States). Samples were clamped into the load frame with the free end of the substrate in the top clamp and the panel the adhesive was stuck to was placed in a fixture that maintained a 90° angle during peel. The sample was peeled at 100 mm/min (4 in/min). Samples were stretched for 117 mm of head movement. The first 25 mm of peel data was discarded and the average peel force over the next 89 mm was recorded.

### Static Shear Strength Test Method

Static shear strength tests were conducted using 12.7 mm wide adhesive tapes prepared from adhesives in Table 6. A stainless-steel panel was cleaned by wiping with first heptane, then acetone, and drying. A 1.0 mm (0.048 in.) thick adhesive disposed between two release liners was cut into 2.54 cm×10.15 cm (1.0 in.×4.0 in.) strips, the RF02N release liner removed, and the adhesive was applied to a 0.25 mm (0.020 in.) thick PET backing of equal size. The remaining RF22N release liner on the PET backed adhesive was removed and the adhesive was applied to a stainless-steel panel with a rubber roller with hand pressure such that a 12.7 mm×25.4 mm (0.50 in.×1.0 in.) portion of each adhesive tape was in firm contact with the panel and the trailing end portion of the PET backed adhesive was free (i.e., not attached to the panel). The trailing end was wrapped around an stainless-steel hook and adhered back onto itself. Then samples were compressed with a 4.54 kg (10 lb.) roller using four total passes over the adhesive. Samples were aged at 23.9° C. and 75% humidity for 72 hours before testing.

Each test substrate (stainless steel panel, adhesive with backing, aluminum hook) was held in a rack so that the panel formed an angle of 180° with the extended hook end, let dwell for 10 minutes at testing temperature, then a 100 gram or a 250 gram weight was attached to the hook end. The test was conducted under controlled temperature (70° C. or 120° C. as indicated in Table 7) and humidity conditions and the time elapsed for each adhesive (after initial dwell time) to separate from the test panel was recorded as the shear strength in minutes.

### Creep Resistance Test Method

The examples were analyzed using a DHR-3 parallel plate rheometer equipped with a Peltier plate accessory (TA Instruments, New Castle, Delaware, USA) to characterize the creep properties of each sample as a function of time. Rheology samples were formed into an adhesive film approximately 1 mm thick between silicone coated release liners. Samples were then punched out with an 8 mm circular die, removed from the release liners, centered onto the 8 mm diameter parallel plate upper fixture of the rheometer, and compressed down to the Peltier plate until the edges of the sample were uniform with the edges of the top plate.

Samples were conditioned at the test start temperature of 110° C. under an axial force control of 40 grams with a sensitivity of +/−30 grams for 120 seconds and then the axial force adjustment was disabled to hold the plates at a fixed gap for the remainder of the test. A fixed stress of 8,000 Pa was then applied for 1860 seconds. While many physical parameters of the material are recorded during the creep test, Compliance (J) is used to compute Creep Resistance.

The Creep Resistance of the polymer is a term used to describe the long-time creep behavior of the material by measuring the slope of the compliance versus time and inverting that value to yield a viscosity (Pa·s). It is calculated at the completion of the test by extracting the compliance values at about 20 minutes (1199.5 seconds) and about 30 minutes (1795.1 seconds) according to the following formula:

$$Creep \text{ } Resistance = [ \text{} ( Compliance ( 1 / Pa ) at 1795 s - Compliance ( 1 / Pa ) at 1199 s ) \div {( 1795 s - 1199 s ) ]}^{∧} - 1$$

### Method for Determining Probe

The probe tack of the samples was measured on TA texture analyzer (TA Instruments, New Castle, Delaware, USA). A stainless steel hemispherical probe was used to apply a force of 50 g onto the samples, held for 10 seconds, and retracted at 1 mm/sec while the force and distance from the sample were recorded. The tack was recorded as the area under the force-distance curve.

### Haze Measurements

All measurements were carried out following the ASTM D 1003-92 requirements using the HunterLab Ultrascan Pro instrument (Reston, Virginia, USA). LCD glass (Corning Inc., Corning, New York, USA) was used throughout the tests. Each glass slide was cleaned with solvent and dried using Kimwipes (Kimberly-Clark, Irving, Texas). In a typical procedure, an adhesive transfer tape sample was cut into a rectangle with minimum dimensions 2.75 inches×1.75 inches to span the entrance port of the HunterLab Ultrascan Pro. The RF02N liner was removed from the adhesive transfer tape to expose the adhesive. Then the adhesive was laminated onto the glass slide using a 2 kg rubber roller, leaving no bubbles after the lamination. The sample was then left under 65° C./90% relative humidity conditions before the RF22N liner was removed, leaving only the adhesive on the LCD glass slide. The haze measurements were then carried out with the clear glass slide used as a control. Haze values below 1 were desired for successful optically clear adhesive applications.

### EXAMPLES

### Preparation of Adhesive Transfer Tapes in Table 2

The reagents indicated for each sample in Table 2 were added to a glass jar followed by toluene to make a 33% solids solution. The jar was sealed, and the contents were mixed on a roller for 12 hours to provide a homogenous solution. The solution was then coated on a RF22N release liner using a knife coater with a gap of 5 mil (127 μm). The coated sample was placed in an oven at 70° C. for 15 minutes. The sample was then exposed to 2 Mrad of e-beam radiation followed by laminating a RF02N release liner onto the sample.

### Preparation of Adhesive Transfer Tapes in Table 4

The reagents indicated for each sample in Table 4 were added to a glass jar followed by toluene to make a 33% solids solution. The jar was sealed, and the contents were mixed on a roller for 12 hours to provide a homogenous solution. The solution was then coated on a RF22N release liner using a knife coater with a gap of 150 μm. The coated sample was placed in an oven at 70° C. for 15 minutes and then crosslinked using 5 J/cm2 broad spectrum UVA radiation followed by laminating a RF02N release liner onto the sample.

### Preparation of Adhesive Transfer Tapes CE-5 to C-9 and EX-8 to EX-11 in Table 6

The reagents indicated for each sample in Table 6 were added to a glass jar followed by toluene to make a 33% solids solution. The jar was sealed, and the contents were mixed on a roller for 12 hours to provide a homogenous solution. The solution was then coated on a RF22N release liner using a knife coater with a gap of 5 mil (127 μm). The coated sample was placed in an oven at 70° C. for 30 minutes. The sample was then laminated to desired thickness after which a RF02N release liner was laminated onto the sample and covered with aluminum foil to avoid exposure to light. For post UV cure test results, the adhesive was subjected to 9.6 J/cm² of UV light (395 nm) after lamination of the testing substrate.

### Preparation of Core-Sheath Filament by Hand-Rolling (EX-12 in Table 6)

The reagents indicated for EX-12 in Table 6, except for the LDPE, were added to a glass jar followed by toluene to make a 33% solids solution. The jar was sealed, and the contents were mixed on a roller for 12 hours to provide a homogenous solution. The solution was then coated on a RF22N release liner using a knife coater with a gap of 5 mil (127 μm). The coated sample was placed in an oven at 70° C. for 30 minutes. The sample was then laminated to desired thickness after which a RF02N release liner was laminated onto the adhesive sample and covered with aluminum foil to avoid exposure to light.

Films of non-tacky sheaths were prepared by hot melt pressing pellets of LPDE to average thickness of 7-10 mil (0.1778-0.254 mm) in a Carver press at 160° C. Rectangles of film 3.77 cm in width and 7-15 cm in length were cut and the RF02N liner of the adhesive sample was removed and placed on the film with the adhesive in contact with the film. The RF22N liner was then removed, and the adhesive/film sample was rolled to make a core/sheath filament 12 mm in diameter. This filament was then placed into a single screw dispenser and dispensed at 160° C. onto RF22N release liner. A sheet of RF02N release liner was placed on top of the dispensed adhesive and the adhesive disposed between two release liners was pressed in a carver press at 160° C. to an average thickness of 48 mils (1.0 mm). For testing of the adhesives (EX-12) post UV cure, the adhesive was subjected to 9.6 J of UV light (395 nm) after lamination to the testing substrate.

TABLE 2
Formulations (numbers denote grams)

| Sample | D1340KT | 5340 | PPO | LIR KL-10 | LIR-50 | LIR-410 |
|---|---|---|---|---|---|---|
| CE-1 | 60 | 40 | | | | |
| CE-2 | 60 | 40 | 20 | | | |
| EX-1 | 60 | 40 | | 20 | | |
| EX-2 | 60 | 40 | | | 20 | |
| EX-3 | 60 | 40 | | | | 20 |

TABLE 3
Rheological and Probe Tack Test Results
for Formulations in Table 2

| | | G′ at | | | Probe |
|---|---|---|---|---|---|
| | Tg | 25° C. | Tan δ at | Tan δ at | Tack |
| Sample | (° C.) | (kPa) | 25° C. | 150° C. | (g*mm) |
| CE-1 | −12.24 | 149 | 0.17 | 0.49 | 11.61 |
| CE-2 | −25.21 | 78 | 0.17 | 0.61 | 16.41 |
| EX-1 | −25.12 | 97 | 0.3 | 0.57 | 29.44 |
| EX-2 | −24.2 | 101 | 0.28 | 0.58 | 28.34 |
| EX-3 | −23.86 | 119 | 0.27 | 0.47 | 26.92 |

TABLE 4
Formulations (numbers denote grams)

| | | | | LIR | LIR- | LBR- | P- | |
|---|---|---|---|---|---|---|---|---|
| Sample | D1340KT | PPO | A80 | KL-10 | 30 | 307 | 90 | BP |
| CE-3 | 50 | 50 | | | | | | 2 |
| CE-4 | 50 | | 50 | | | | | 2 |
| EX-4 | 50 | | | | 50 | | | 2 |
| EX-5 | 50 | | | 40 | | | 10 | 2 |
| EX-6 | 50 | | | | | 50 | | 2 |
| EX-7 | 50 | | | 50 | | | | 2 |

TABLE 5
Rheological and Haze Test Results for Formulations in Table 4

| Sample | Haze | Tan δ at 70° C. | Tan δ at 150° C. |
|---|---|---|---|
| CE-3 | 0.98 | 0.682 | 0.520 |
| CE-4 | 1.03 | 0.581 | 0.598 |
| EX-4 | 0.54 | 0.911 | 1.172 |
| EX-5 | 0.65 | 1.101 | 1.007 |
| EX-6 | 0.76 | 0.821 | 0.774 |
| EX-7 | 0.60 | 1.039 | 0.876 |

TABLE 6
Formulations (numbers denote grams)

| Sample | 1161 | D1340KT | 5340 | P-140 | PPO | LBR-361 | UC-102M | UC-203M | TPO | BP | LDPE |
|---|---|---|---|---|---|---|---|---|---|---|---|
| CE-5 | 10 | 36 | | 30 | 8 | 6 | | | | | |
| CE-6 | 10 | 40 | | 40 | | 10 | | | | | |
| CE-7 | 10 | 40 | | 40 | | | 10 | | | 3 | |
| CE-8 | 10 | 40 | | 40 | | 10 | | | 3 | | |
| CE-9 | 10 | 40 | | 40 | | | 10 | | 3 | | |
| EX-8 | | 45 | | 45 | | | | 10 | 3 | | |
| EX-9 | | 45 | | 45 | | | 10 | | 3 | | |
| EX-10 | | 50 | 42 | | | | 5 | | 3 | | |
| EX-11 | | 48 | 40 | | | | 5 | | 3 | | 4 |
| EX-12* | | 48 | 40 | | | | 5 | | 3 | | 4 |

*EX-12 was made with 4 wt % LDPE as sheath material in core/sheath construction by hand-rolling.

TABLE 7
90° Peel, Static Shear, Rheological, and Creep
Resistance Test Results for Formulations in Table 6

| | Post-cure | Pre-cure | Post-cure | | |
|---|---|---|---|---|---|
| | 90° Peel | 70° C. | 120° C. | | |
| | Stainless | Stainless | Stainless | | Post-cure |
| | Steel | Steel Static | Steel Static | Post-cure | Creep |
| | (N/cm) | Shear (min) | Shear (min) | Tan δ | Resistance |
| Sample | 4″/min | 100 grams | 250 grams | at 110° C. | at 110° C. |
| CE-5 | 39 | 10000 | 28 | 0.3 | 8.6 |
| CE-6 | 40 | 8000 | 1 | 0.3 | 0.1 |
| CE-7 | 38 | 28 | 1 | 0.5 | 0.1 |
| CE-8 | 38 | 26 | 2 | 0.6 | 0.5 |
| CE-9 | 37 | 24 | 8 | 0.3 | 0.5 |
| EX-8 | 36 | 1850 | 10000 | 0.2 | 696 |
| EX-9 | 37 | 22 | 10000 | 0.2 | 658 |
| EX-10 | 37 | 10000 | 10000 | 0.2 | 332 |
| EX-11 | 36 | 9864 | 10000 | 0.2 | 359 |
| EX-12 | 37 | 10000 | 10000 | 0.2 | 377 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An adhesive composition comprising:
20 wt. % to 80 wt. % of a polymer selected from the group consisting of a radial styrene-isoprene block copolymer, a radial styrene-butadiene block copolymer, and combinations thereof;
a multifunctional (meth)acrylate; and
3 wt. % to 80 wt. % of a liquid rubber,
wherein the liquid rubber is selected from the group consisting of an isoprene rubber, a butadiene rubber, and combinations thereof, and wherein the liquid rubber has a molecular weight of 300 Daltons to 100,000 Daltons.

2. The adhesive composition of claim 1, wherein the adhesive composition comprises 40 wt. % to 70 wt. % of the polymer.

3. The adhesive composition of claim 1, wherein the adhesive composition comprises 3 wt. % to 50 wt. % of the liquid rubber.

4. The adhesive composition of claim 1, wherein the liquid rubber has a molecular weight of 5,000 Daltons to 60,000 Daltons.

5. The adhesive composition of claim 1, further comprising a tackifier.

6. The adhesive composition of claim 1, further comprising an additive selected from the group consisting of a plasticizer, an anti-oxidant, a thermal stabilizer, a UV blocker, a photoinitiator, and combinations thereof.

7. (canceled)

8. The adhesive composition of claim 1, wherein the multifunctional (meth)acrylate is selected from the group consisting of a diacrylate, a triacrylate, a tetraacrylate, a hexaacrylate, and combinations thereof.

9. The adhesive composition of claim 1, wherein the adhesive composition includes essentially no linear styrene-isoprene block copolymer and no linear styrene-butadiene block copolymer.

10. A pressure-sensitive adhesive comprising the adhesive composition of claim 1.

11. An optically clear adhesive comprising the adhesive composition of claim 1.

12. A cured adhesive composition comprising the adhesive composition of claim 1, the cured adhesive composition being a product resulting from irradiation at 215 nm to 410 nm of the adhesive composition.

13. The cured adhesive composition of claim 12, wherein the cured adhesive composition exhibits a static shear performance of greater than 1000 minutes as measured by the Shear Strength Test Method.
